(19) United States
(12) Patent Application Publication
(10) Pub. No.: US 2022/0040791 A1
(43) Pub. Date: Feb. 10, 2022

(54) LASER WELDING SYSTEMS INCLUDING IN CONNECTION WITH BATTERY SYSTEMS, AND RELATED METHODS

(71) Applicant: Kulicke and Soffa Indsutries,Inc., Fort Washington, PA (US)

(72) Inventors: Richard J. McCartney, JR., Chandler, AZ (US); Peter Julius Klaerner, Corona, CA (US)

(21) Appl. No.: 17/396,509

(22) Filed: Aug. 6, 2021

Related U.S. Application Data
(60) Provisional application No. 63/063,426, filed on Aug. 9, 2020.

(51) Int. Cl. B23K 26/21; H01M 50/516; B23K 37/04; B25J 11/00

(52) U.S. Cl. CPC B23K 26/21; H01M 50/516; B23K 2101/36; B25J 11/005; B23K 37/04

(57) ABSTRACT

A laser welding system is provided. The laser welding system includes a tooling assembly for securing a conductor against a workpiece. The tooling assembly includes a spring assembly for pressing the conductor against the workpiece. The laser welding system also includes a laser source for providing laser energy for selectively welding the conductor to the workpiece.

### CROSS-REFERENCE TO RELATED APPLICATION

This application claims the benefit of U.S. Provisional Application No. 63/063,426, filed Aug. 9, 2020, the contents of which is incorporated herein by reference

### FIELD

The invention relates to laser welding, and more particularly, to improved systems and methods for performing laser welding operations including as related to applying a conductor to a battery system.

### BACKGROUND

Battery assemblies are used in many applications such as, for example, electric vehicles, marine applications, and many others. Such battery assemblies include electrical conductors (e.g., collectors) providing interconnection between multiple batteries in the battery assembly.

It would be desirable to provide improve systems and methods for providing electrical interconnection between a plurality of batteries in a battery assembly, and in other applications.

### SUMMARY

According to an exemplary embodiment of the invention, a laser welding system is provided. The laser welding system includes a tooling assembly for securing a conductor against a workpiece. The tooling assembly includes a spring assembly for pressing the conductor against the workpiece. The laser welding system also includes a laser source for providing laser energy for selectively welding the conductor to the workpiece.

According to another exemplary embodiment of the invention, a method of welding a conductor to a workpiece is provided. The method includes the steps of: pressing the conductor against the workpiece with a tooling assembly, the tooling assembly including a spring assembly for pressing the conductor against the workpiece; and selectively welding the conductor to the workpiece using a laser source.

According to yet another exemplary embodiment of the invention, another laser welding system is provided. The laser welding system includes a first robot including a tooling assembly for securing a conductor against a workpiece. The tooling assembly includes a spring assembly for pressing the conductor against the workpiece. The laser welding system also includes a second robot including a laser source for providing laser energy for selectively welding the conductor to the workpiece.

According to yet another exemplary embodiment of the invention, another method of welding a conductor to a workpiece is provided. The method includes the steps of: supporting the workpiece; securing the conductor against the workpiece with a tooling assembly of a first robot, the tooling assembly including a spring assembly for pressing the conductor against the workpiece; and selectively welding the conductor to the workpiece using a laser source of a second robot.

According to other exemplary embodiments of the invention, methods of operating the aforementioned laser welding systems are provided, and methods of welding a conductor (e.g., a foil) to a workpiece (e.g., a battery system) is provided.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a block diagram cross-sectional side view of a laser welding system in accordance with an exemplary embodiment of the invention;

FIG. 1B is a top view of a tooling assembly of the laser welding system of FIG. 1A;

FIG. 1C is a detailed view of a portion of FIG. 1B;

FIGS. 2A-2D are various views of a tooling assembly of a laser welding system in accordance with another exemplary embodiment of the invention;

FIGS. 3A-3I are a series of side block diagram views of a laser welding system in accordance with another exemplary embodiment of the invention;

FIGS. 4A-4C are a series of side block diagram views of a laser welding system, configured for interaction with an Automated Guided Vehicle (AGV), in accordance with an exemplary embodiment of the invention;

FIG. 5A is a block diagram cross-sectional side view of elements of a laser welding system pressing against a workpiece in accordance with an exemplary embodiment of the invention; and

FIG. 5B. is a block diagram view of elements of FIG. 5A, illustrating interconnection between a conductor and battery terminals of a workpiece, in accordance with an exemplary embodiment of the invention.

### DETAILED DESCRIPTION

Aspects of the invention relate to use of a laser (e.g., in a laser welding environment) to form a connection in various applications (e.g., to weld a foil to a battery assembly such as a battery module). Additional aspects of the invention relate to aligning and clamping a conductor (such as a foil) against a workpiece (such as a battery assembly) to get a firm contact between a foil and the battery assembly.

Aspects of the invention also relate to a spring based tooling assembly for securing the conductor (e.g., a foil) against a workpiece (e.g., a battery assembly) during a laser welding operation. The spring based tooling assembly can account for different z-axis heights of the workpiece, conductor, and/or a support structure of the laser welding system (e.g., the support structure that supports the workpiece during the laser welding operation).

According to certain exemplary aspects of the invention, springs are attached to actuated plate (as part of a spring assembly) such that they can be moved into and out of a vacuum manifold (part of a vacuum assembly). The vacuum manifold may be used to pick up a conductor (e.g., a foil), thereby allowing the conductor to be placed with aid of an alignment system (e.g., a laser alignment system, an optical alignment system, a mechanical registration system, etc). Springs of the spring assembly may be arranged based on the workpiece layout (e.g., a battery module layout), the conductor layout (e.g., the foil layout), etc. Springs of the spring assembly will be used to apply clamping force to ensure contact between the conductor and workpiece, before laser welding. Laser energy may be configured to pass through each of the springs to a weld location of the conductor. A fume tube may be located inside the spring to: allow targeted extraction of weld fumes; and/or protect springs from weld splash.

The workpiece may be a battery assembly for use in vehicles (e.g., electric vehicles) or in any other application.

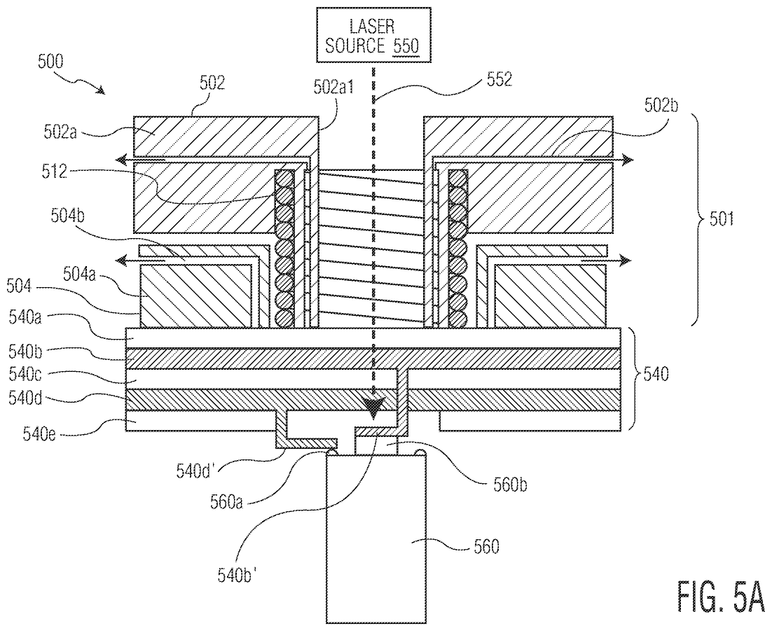

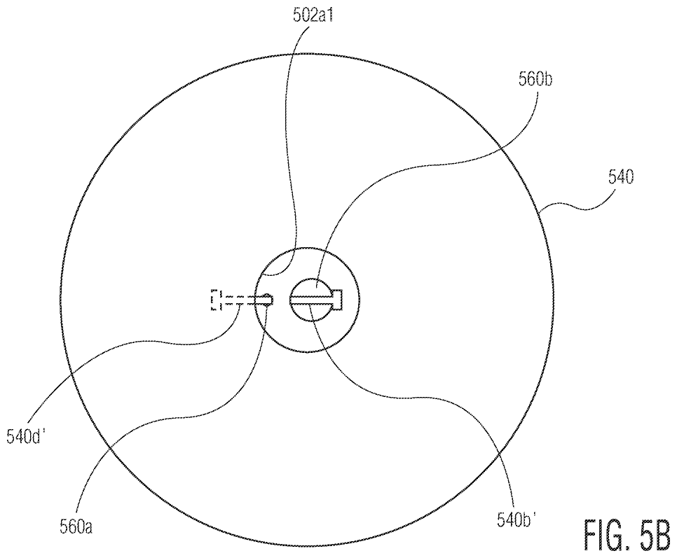

As used herein, the term “conductor” is intended to refer to any type of structure providing an electrically conductive function in connection with a workpiece. The conductor may include conductive and insulative portions, such as various layers (e.g., see conductor 540 in FIG. 5). In applications where the workpiece includes a plurality of batteries (e.g., a battery assembly, a battery module, a battery pack, etc.), the conductor may be a conductive foil (e.g., a multi-layer conductive foil).

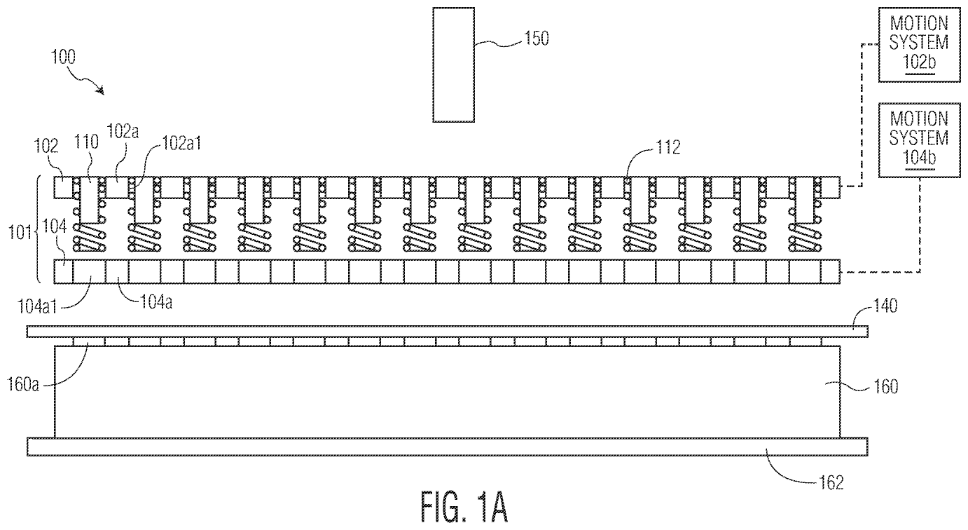

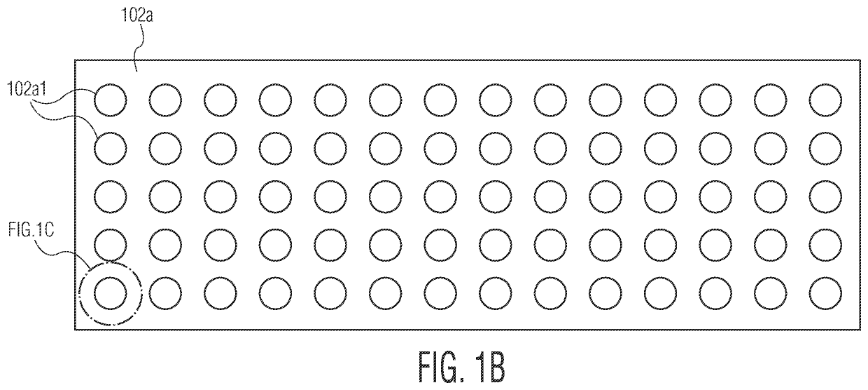

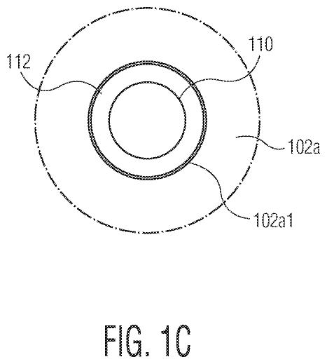

Referring now to FIG. 1A, a laser welding system 100 is provided. Laser welding system 100 includes a tooling assembly 101. Tooling assembly 101 includes a spring assembly 102 and a vacuum assembly 104. Spring assembly 102 includes a body portion 102a defining a plurality of through holes 102a1 (i.e., apertures). Spring assembly 102 also includes a plurality of springs 112 (e.g., where at least a portion of each of the springs 112 is captively held in a corresponding one of the plurality of through holes 102a1). Vacuum assembly 104 includes a body portion 104a defining a plurality of through holes (i.e., apertures) 104a1. FIG. 1A illustrates a portion of each of the plurality of springs 112 protruding through apertures 102a1 prior to contacting a conductor 140 (e.g., a conductive foil) against a workpiece 160 (e.g., battery module). A motion system 102b is provided for moving spring assembly 102 (e.g., along any of a number of motion axes as desired in a given application). A motion system 104b is provided for moving vacuum assembly 104 (e.g., along any of a number of motion axes as desired in a given application). Through the use of motion system 102b and motion system 104b, each of spring assembly 102 and vacuum assembly 104 may be moved relative to one another and/or relative to workpiece 160. Workpiece 160 (e.g., battery module) includes a plurality of batteries 160a, and is supported by a support structure 162. Laser welding system 100 also includes a laser source 150 for providing laser energy for selectively welding conductor 140 to workpiece 160.

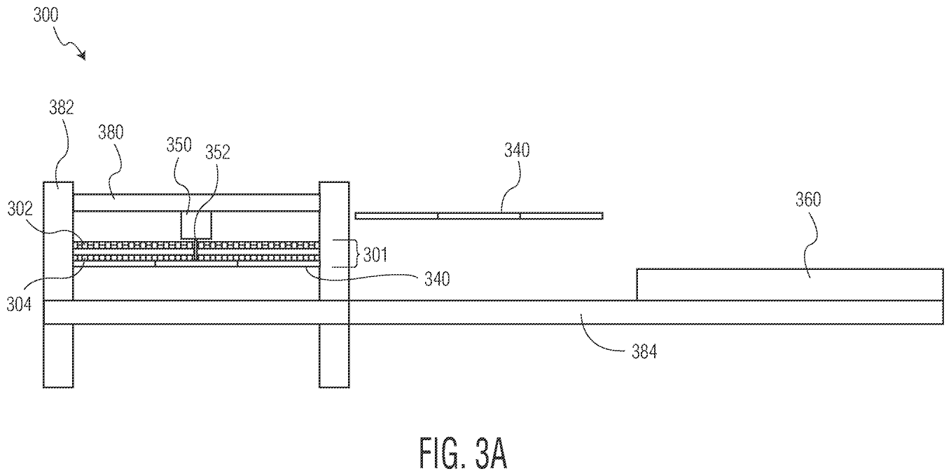

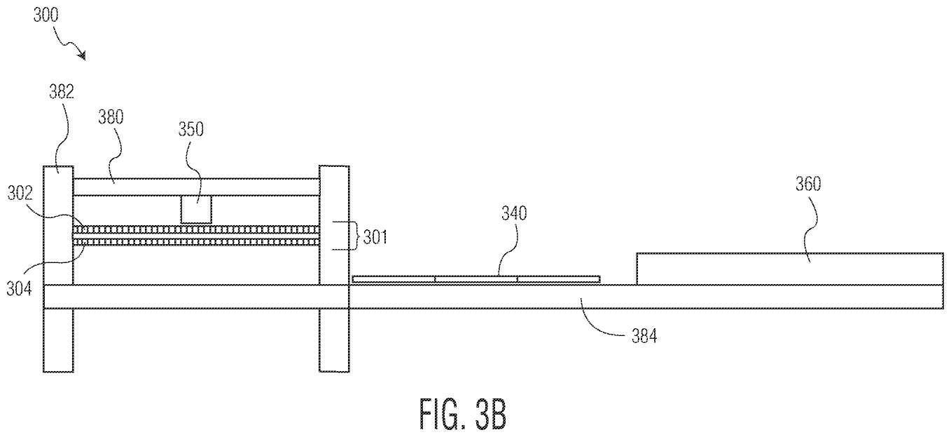

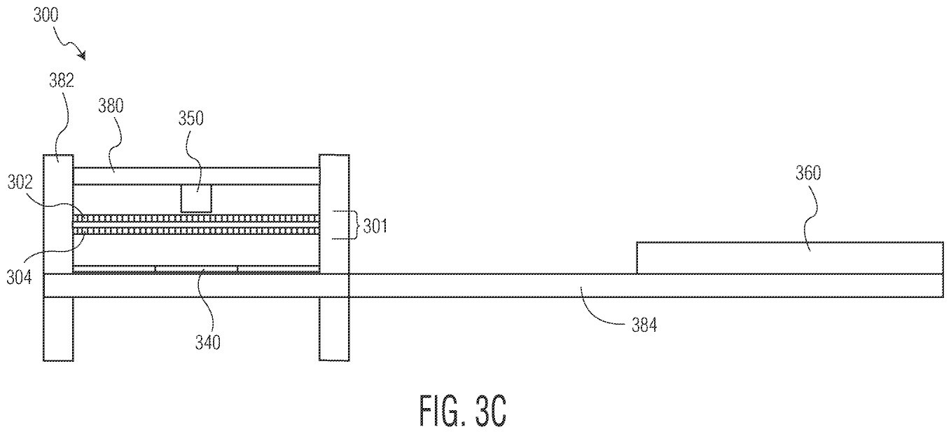

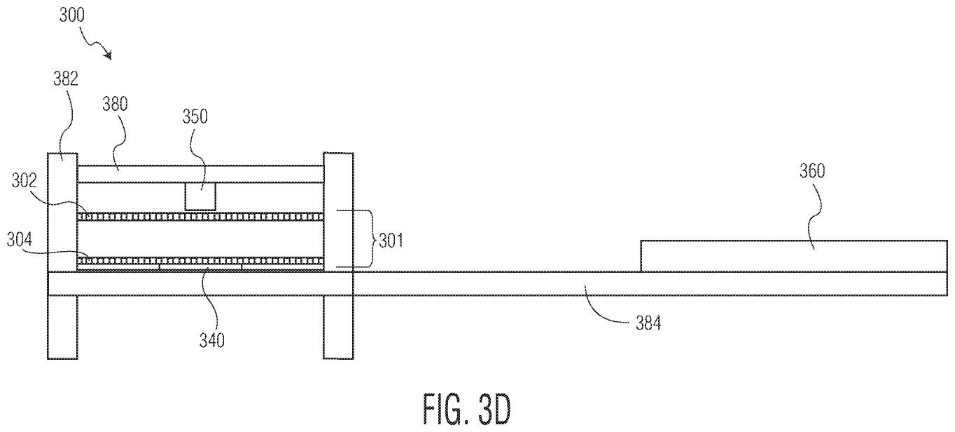

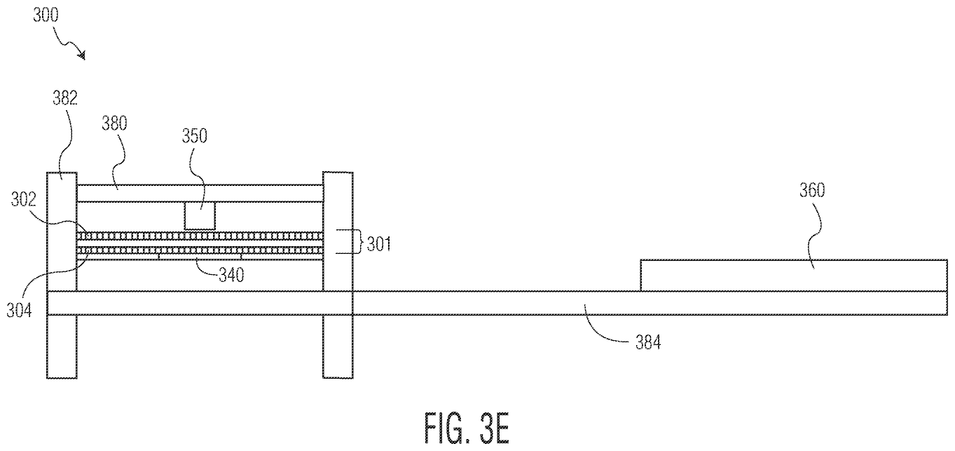

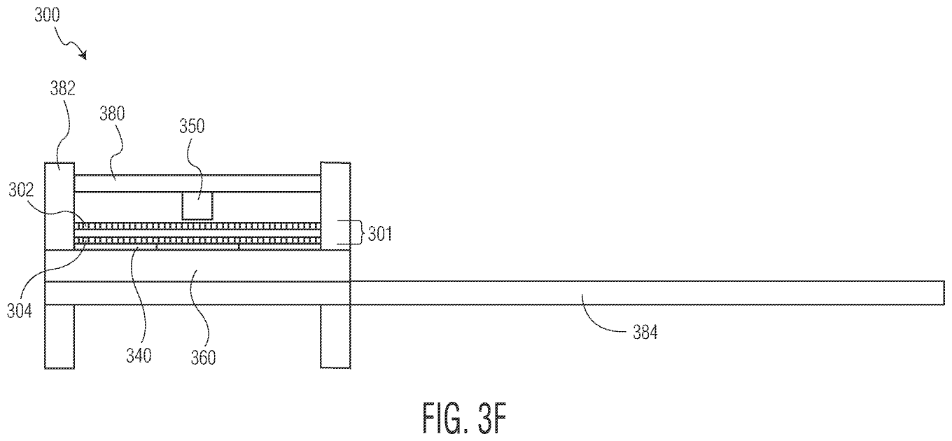

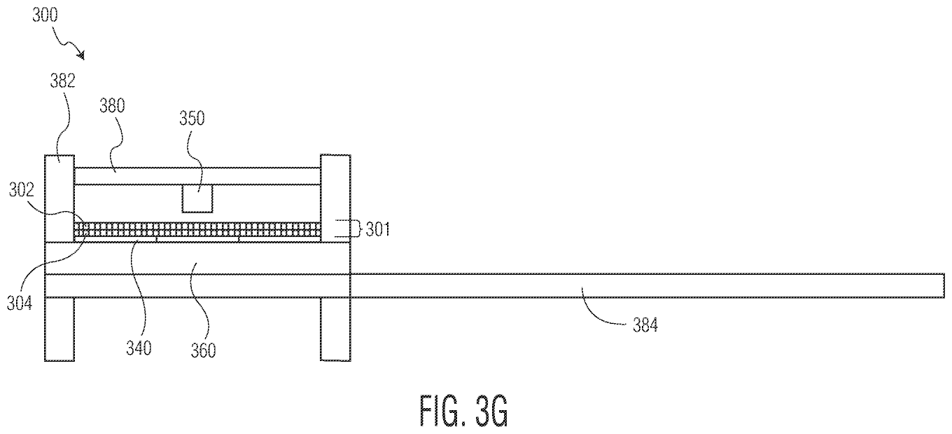

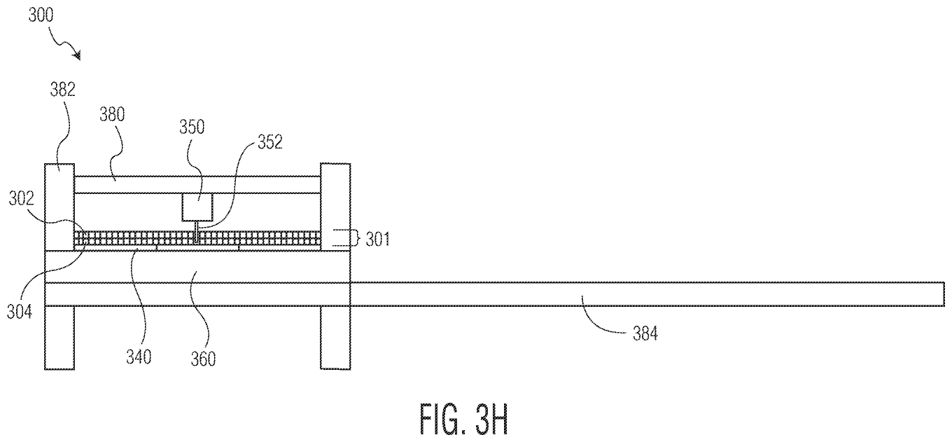

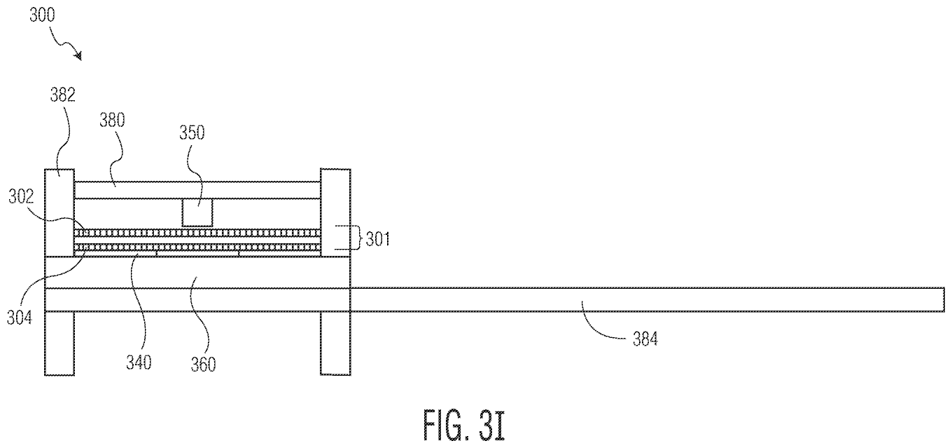

As will be appreciated by those skilled in the art, tooling assembly 101 is used for securing conductor 140 against workpiece 160. Specifically, vacuum assembly 104 is configured to hold conductor 140 (e.g., using vacuum as explained below, for example, in a manner similar to the vacuum used in connection with FIGS. 3D-3F). Then, spring assembly 102 is used for pressing conductor 140 against workpiece 160 (e.g., in a manner similar to the spring assembly pressing the conductor described in connection with FIG. 3G). Then, laser source 150 is used to provide laser energy for selectively welding conductor 140 to workpiece 160 (e.g., in a manner similar to the welding described in connection with FIG. 3H). FIG. 1A also illustrates fume tubes 110 integrated with each of springs 112 such that fumes from the laser welding operation may dissipate.

In FIG. 1A, conductor 140 has already been selectively welded to workpiece 160, and spring assembly 102 has been raised (e.g., using motion system 102b) such that springs 112 are no longer pressing against conductor 140 (either directly or indirectly).

Referring now to FIG. 1B, a top view of body portion 102a is provided, also illustrating the plurality of through holes 102a1. Referring now to FIG. 1C, a detailed view of a portion of the spring assembly 102 from FIG. 1B is illustrated. Specifically, a top view of part of body portion 102a is illustrated including spring 112 and fume tube 110 concentrically arranged in a through hole 102a1. That is, fume tube 110 is illustrated as being arranged concentrically within spring 112, and spring 112 is illustrated as being arranged concentrically within through hole 102a1. Spring 112 and fume tube 110 are supported by body portion 102a (e.g., they are captively held in the corresponding through hole 102a1 of body portion 102a).

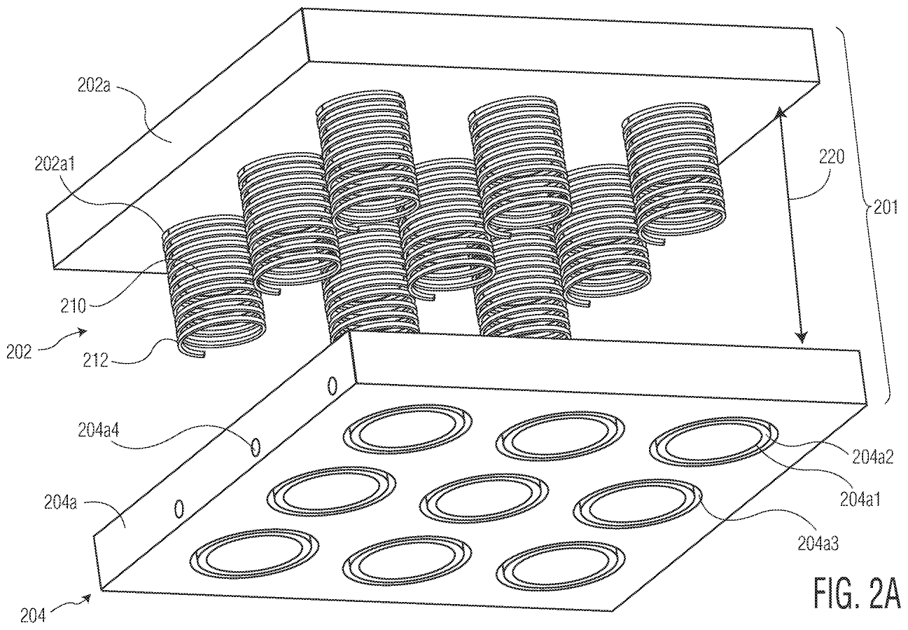

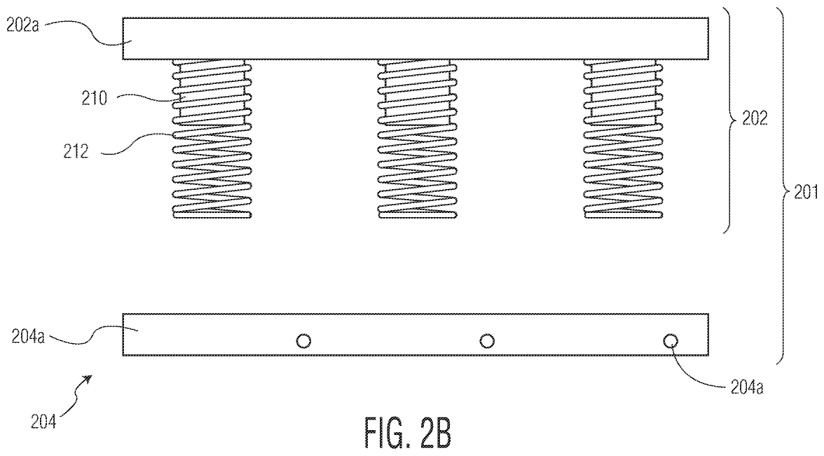

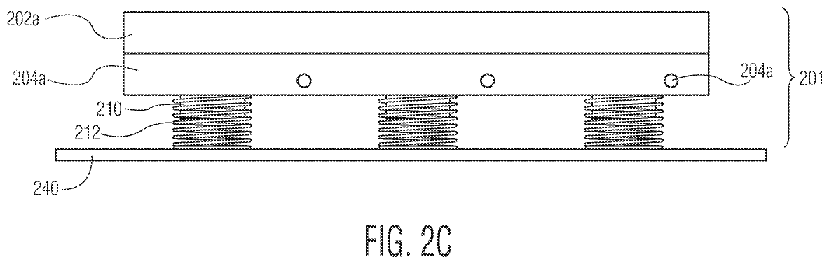

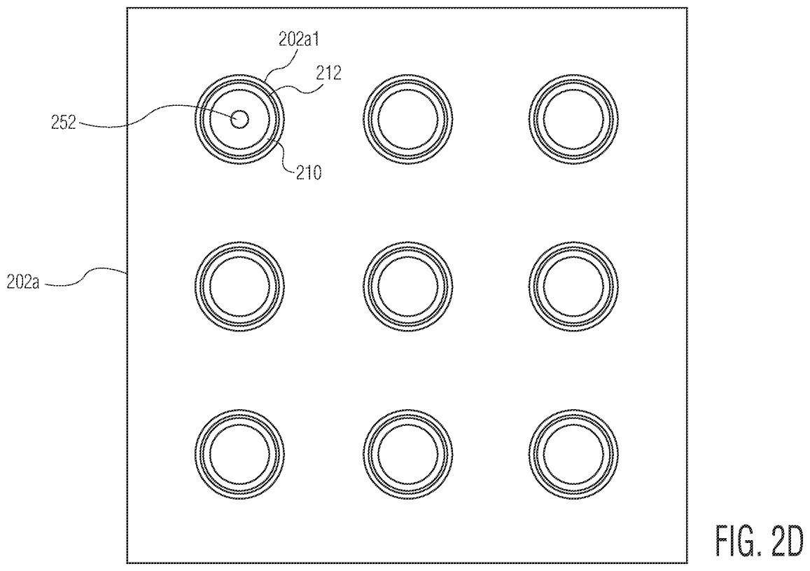

Referring now to FIGS. 2A-2B, perspective and side views of a tooling assembly 201 are provided. Similar to tooling assembly 101 shown in FIG. 1A, tooling assembly 201 includes a spring assembly 202 and a vacuum assembly 204. Spring assembly 202 includes a body portion 202a defining a plurality of through holes 202a1 (i.e., apertures). Spring assembly 202 also includes a plurality of springs 212 (e.g., where at least a portion of each of the springs 212 is captively held in a corresponding one of the plurality of through holes 202a1). Spring assembly 202 also includes a plurality of fume tubes 210, each being integrated with one of springs 212 such that fumes from the laser welding operation may dissipate. Vacuum assembly 204 includes a body portion 204a defining a plurality of through holes (i.e., apertures) 204a1, each of through holes 204a1 being configured to receive a corresponding one of springs 212, whereby springs 212 may press against a workpiece (either directly or indirectly). Vacuum assembly 204 defines a plurality of vacuum channels 204a4 (e.g., configured to be connected to a vacuum source), the plurality of vacuum channels 204a4 being in fluid communication with a plurality of vacuum paths 204a3. Vacuum is drawn through each of vacuum paths 204a3 such that vacuum paths are configured to hold a conductor 240 (e.g., a conductive foil). Vacuum assembly also defines a contact surface 204a2 for contacting the workpiece (either directly or indirectly).

As shown in FIGS. 2A-2B, spring assembly 202 is illustrated with springs 212 in an uncompressed state, with a gap 220 provided between spring assembly 202 and vacuum assembly 204. FIG. 2C illustrates springs 212 in a compressed state, whereby there is no gap 220 provided between spring assembly 202 and vacuum assembly 204. That is, in FIG. 2C, vacuum assembly is holding conductor 240, and spring assembly 202 has been moved to contact vacuum assembly 204, whereby springs 212 are received by through holes 204a1. Springs are compressed while being pressed against conductor 240 (either directly or indirectly) in connection with a welding operation. FIG. 2D illustrates a top view of body portion 202a of spring assembly 202 with laser energy 252 transmitted through the center of a through hole 202a1 (e.g., aperture) of body portion 202a of spring assembly 202 (with laser energy 252 also being transmitted through the center of through hole 204a1 (and corresponding spring 212) to weld a portion of conductor 240 to a workpiece).

FIGS. 3A-3I illustrate a process of using of a laser welding system 300 in accordance with an exemplary embodiment of the invention. In FIG. 3A, a tooling assembly 301 is illustrated supported by support structure 382. A vacuum assembly 304 is holding a conductor 340. A laser source 350 is illustrated transmitting laser energy 352 through spring assembly 302 and vacuum assembly 304. A workpiece 360 (e.g., battery module) is shown outside of the welding site.

Tooling assembly 301 includes a spring assembly 302 and a vacuum assembly 304. Spring assembly 302 includes a body portion defining a plurality of through holes (i.e., apertures) (similar to through holes 102a1 defined by body portion 102a of spring assembly 102 of FIG. 1A). Spring assembly 302 also includes a plurality of springs (e.g., where at least a portion of each of the springs is captively held in a corresponding one of the plurality of through holes) (similar to springs 112 of spring assembly 102 of FIG. 1A). Spring assembly 302 may also include a plurality of fume tubes (similar to fume tube 110 of spring assembly 102 of FIG. 1A), each being integrated with one of the springs such that fumes from the laser welding operation may dissipate. Vacuum assembly 304 includes a body portion defining a plurality of through holes (i.e., apertures) (similar to through holes 104a1 defined by body portion 104a of vacuum assembly 104 of FIG. 1A), each of the through holes being configured to receive a corresponding one of springs of spring assembly 302, whereby the springs are configured to press against a conductor 340 (either directly or indirectly), with conductor 340 configured to be pressed against workpiece 360 (either directly or indirectly). Vacuum assembly 304 defines a plurality of vacuum channels (e.g., configured to be connected to a vacuum source), the plurality of vacuum channels being in fluid communication with a plurality of vacuum paths.

Referring now to FIG. 3B, conductor 340 is illustrated outside of support structure 382. In FIG. 3C, conductor 340 has been transported beneath vacuum assembly 304. In FIG. 3D, vacuum assembly 304 is moved down to make contact with conductor 340. In FIG. 3E, vacuum assembly 304 is moved up while holding conductor 340 using, for example, a vacuum. In FIG. 3F, workpiece 360 (e.g., battery module) is moved beneath vacuum assembly 304 of tooling assembly 301 prior to a welding operation. In FIG. 3G, spring assembly 302 is moved down to make springs (not illustrated) compress and make contact against conductor 340 (either directly or indirectly), compressing conductor 340 against workpiece 360, just prior to a welding operation. In FIG. 3H, laser energy 352 is transmitted from laser source 350 in connection with a welding operation. In FIG. 3I, spring assembly 302 is moved up to release springs (not illustrated) from the compressed state.

FIGS. 3A-3I are described in a simplistic and generic manner—it being understood that various details of the operation of laser welding system 300 are not limited to any specific implementation. For example, prior to conductor 340 being held by vacuum assembly 304, conductor 340 may be moved (e.g., from a conductor supply) using any desired structure or method.

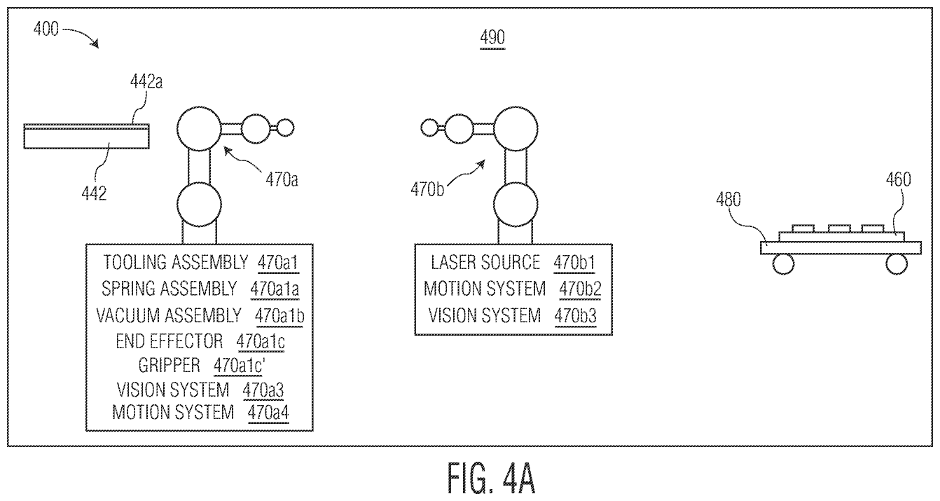

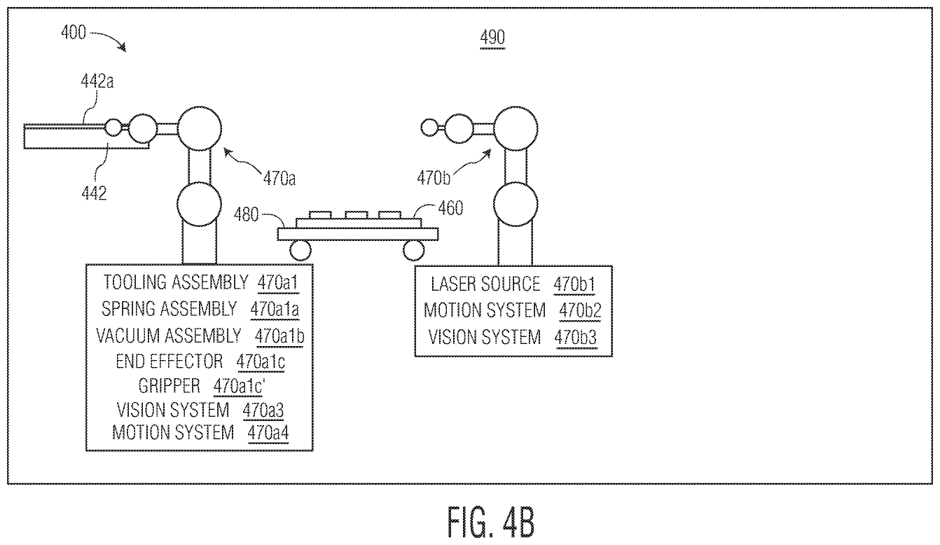

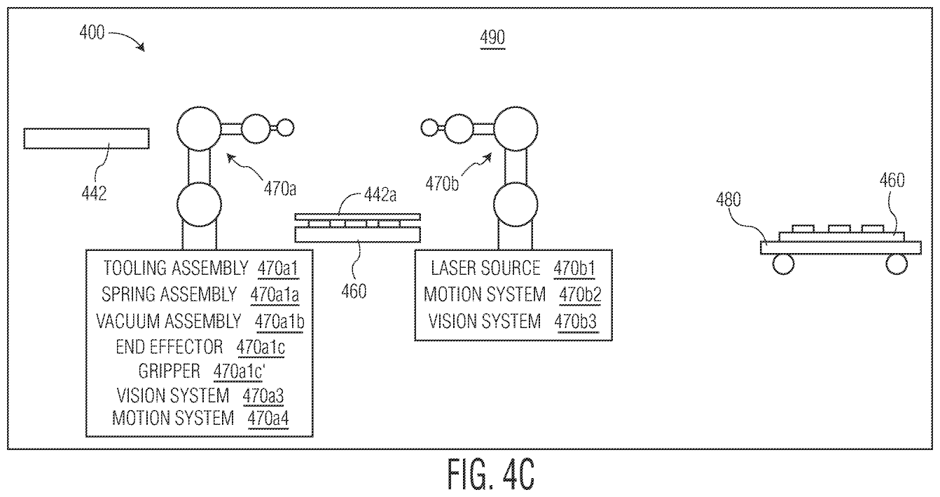

FIGS. 4A-4C illustrate a process of using of a laser welding system 400 in accordance with an exemplary embodiment of the invention. In FIG. 4A, workpiece 460 (e.g., battery module) is illustrated supported by an autonomous guided vehicle (AGV) 480 within a facility 490. A first robot 470a (including a tooling assembly 470a1 for securing a conductor 442a against a workpiece 460) and a second robot 470b (including a laser source 470b1 for providing laser energy for selectively welding conductor 442a to workpiece 460) are illustrated. At least one of first robot 470a and second robot 470b may be a 6-axis robot.

Tooling assembly 470a1 of first robot 470a may include a spring assembly 470a1a and a vacuum assembly 470a1b (similar to other tooling assemblies described herein). Alternatively, or additionally, tooling assembly 470a1 may include an end effector 470a1c (including a gripper 470a1c′). First robot 470a may further include a vision system 470a3 and a motion system 470a4 (to assist in securing conductor 442a against workpiece 460). Second robot 470b is illustrated, including a laser source 470b1, a motion system 470b2, and a vision system 470b3 (to assist in selectively welding conductor 442a to workpiece 460). Although FIGS. 4A-4C show first robot 470a and second robot 470b each having its own vision system (i.e., vision system 470a3 and vision system 470b3, respectively), it is understood that a single system may be used for both first robot 470a and second robot 470b. In FIG. 4B, workpiece 460 is transported by AVG 480 to an area between first robot 470a and second robot 470b. First robot 470a is illustrated removing a conductor 442a from a conductor supply 442 (although other techniques may be used to move conductor 442a). In FIG. 4C, conductor 442a is shown placed on workpiece 460. With conductor 442a on conductor 460, first robot may be used to secure conductor 442a against workpiece 460 (e.g., using spring assembly 470a1a), and then second robot 470b may be used to selectively weld conductor 442a to workpiece 460.

Referring now to FIG. 5A, a cross-section of a laser welding system 500 is illustrated in accordance with an exemplary embodiment of the invention. Details of laser welding system may be utilized in connection with any other embodiment of the invention described herein (e.g., laser welding system 100, tooling system 200, laser welding system 300, laser welding system 400), or otherwise within the scope of the invention. A conductor is shown as a multilayered conductor 540 (e.g. multilayered conductive foil), including conductive layer 540b and conductive layer 540d. Multilayered conductor 540 also includes insulation layer 540a, insulation layer 540c and insulation layer 540e. A portion 540d′ of conductive layer 540d (e.g., a conductive tab) is aligned with terminal 560a of battery module 560 (e.g., a battery). A portion 540b′ of conductive layer 540b (e.g., a conductive tab) is aligned with terminal 560b of battery module 560.

The multilayered conductor 540 is held partially by a vacuum being pulled (as indicated by solid arrows) through vacuum channels 502b and vacuum channels 504b. Spring 512 is illustrated in a compressed state, compressing the multilayered conductor 540 against workpiece 560. Laser energy 552 is transmitted from laser source 550 through a through hole 502a1 (e.g., an aperture) of spring assembly 502 of tooling assembly 501, thereby selectively welding conductor 540 to workpiece 560 (i.e., welding portion 540d′ of conductive layer 540d to terminal 560a of battery module 560, welding portion 540b′ of conductive layer 540b to terminal 560b of battery module 560, etc.).

FIG. 5B is a simplified top view of a portion of conductor 540, and a portion of workpiece 560. Portion 540d′ of conductive layer 540d (e.g., a conductive tab) has now been welded (using laser source 550) to terminal 560a of battery module 560 (e.g., a battery). Portion 540b′ of conductive layer 540b (e.g., a conductive tab) has now been welded (using laser source 550) to terminal 560b of battery module 560.

As will be appreciated by those skilled in the art, any features of one embodiment of the invention (e.g., the embodiment of any of FIGS. 1A-1C, FIGS. 2A-2D, FIGS. 3A-3I, FIGS. 4A-4C, FIG. 5A-5B, or any other embodiment within the scope of the invention) may be integrated into other embodiments of the invention (e.g., the embodiment of any of FIGS. 1A-1C, FIGS. 2A-2D, FIGS. 3A-3I, FIGS. 4A-4C, FIG. 5A-5B, or any other embodiment within the scope of the invention).

Although certain aspects of the invention illustrate springs from a spring assembly directly pressing a conductor against a workpiece, it is not limited thereto. More specifically, another structure (e.g., an application specific part) may be positioned between the springs and the conductor, thus providing an “indirect” pressing of the springs against the conductor.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A laser welding system comprising:
a tooling assembly for securing a conductor against a workpiece, the tooling assembly including a spring assembly for pressing the conductor against the workpiece; and
a laser source for providing laser energy for selectively welding the conductor to the workpiece.

2. The laser welding system of claim 1 wherein the tooling assembly also includes a vacuum assembly configured to hold the conductor prior to the conductor being pressed against the workpiece with the spring assembly.

3. The laser welding system of claim 1 wherein the conductor is a conductive foil, and the workpiece is a battery assembly including a plurality of batteries.

4. The laser welding system of claim 1 wherein the conductor is a conductive foil, and the workpiece includes at least one of a battery module and a battery pack.

5. The laser welding system of claim 1 wherein the tooling assembly includes a plurality of through holes for receiving the laser energy from the laser source.

6. The laser welding system of claim 5 wherein the spring assembly includes a plurality of spring members provided in at least a portion of the through holes of the tooling assembly.

7. A method of welding a conductor to a workpiece, the method comprising the steps of:
pressing the conductor against the workpiece with a tooling assembly, the tooling assembly including a spring assembly for pressing the conductor against the workpiece; and
selectively welding the conductor to the workpiece using a laser source.

8. The method of claim 7 further comprising the step of holding the conductor with a vacuum assembly of the tooling assembly prior to the step of pressing.

9. The method of claim 7 wherein the conductor is a conductive foil, and the workpiece is a battery assembly including a plurality of batteries.

10. The method of claim 7 wherein the conductor is a conductive foil, and the workpiece includes at least one of a battery module and a battery pack.

11. The method of claim 7 wherein the tooling assembly includes a plurality of through holes for receiving laser energy from the laser source.

12. The method of claim 11 wherein the spring assembly includes a plurality of spring members provided in at least a portion of the through holes of the tooling assembly.

13. A laser welding system comprising:
a first robot including a tooling assembly for securing a conductor against a workpiece, the tooling assembly including a spring assembly for pressing the conductor against the workpiece; and
a second robot including a laser source for providing laser energy for selectively welding the conductor to the workpiece.

14. The laser welding system of claim 13 wherein the tooling assembly also includes a vacuum assembly configured to hold the conductor prior to the conductor being pressed against the workpiece with the spring assembly.

15. The laser welding system of claim 13 wherein the first robot and the second robot are configured to interact in synchronization with an automated guided vehicle (AGV) for supporting the workpiece.

16. The laser welding system of claim 13 wherein the conductor is a conductive foil, and the workpiece is a battery assembly including a plurality of batteries.

17. The laser welding system of claim 13 wherein the conductor is a conductive foil, and the workpiece includes at least one of a battery module and a battery pack.

18. The laser welding system of claim 13 wherein the tooling assembly defines a plurality of through holes for receiving the laser energy from the laser source.

19. The laser welding system of claim 18 wherein the spring assembly includes a plurality of spring members provided in at least a portion of the through holes of the tooling assembly.

20. The laser welding system of claim 13 wherein at least one of the first robot and the second robot is a 6-axis robot.

21. The laser welding system of claim 13 wherein the tooling assembly is an end effector.

22. A method of welding a conductor to a workpiece, the method comprising the steps of:
supporting the workpiece;
securing the conductor against the workpiece with a tooling assembly of a first robot, the tooling assembly including a spring assembly for pressing the conductor against the workpiece; and
selectively welding the conductor to the workpiece using a laser source of a second robot.
